(19) United States
(12) Patent Application Publication
(10) Pub. No.: US 2018/0365697 A1
(43) Pub. Date: Dec. 20, 2018

(54) SUSPICIOUS REMITTANCE DETECTION THROUGH FINANCIAL BEHAVIOR ANALYSIS

(71) Applicants: NEC Laboratories America, Inc., Princeton, NJ (US); NEC Corporation, Tokyo (JP)

(72) Inventors: Tan Yan, Skillman, NJ (US); Haifeng Chen, West Windsor, NJ (US); Ajiro Yasuhiro, Tokyo (JP)

(21) Appl. No.: 15/983,387

(22) Filed: May 18, 2018

Related U.S. Application Data
(60) Provisional application No. 62/520,664, filed on Jun. 16, 2017.

(51) Int. Cl. G06Q 20/40; H04L 29/08; H04W 4/029

(52) U.S. Cl. CPC G06Q 20/4016; H04W 4/029; H04L 67/22; G06Q 20/405

(57) ABSTRACT

A system, method, and computer program product are provided for suspicious remittance detection for a set of users. The method includes detecting, by a processor, unrealistic user location movements, based on login activities and remittance activities. The method includes detecting, by the processor, abnormal user remittance behavior based on account activities and the remittance activities by detecting any users who are silent for a threshold period of time and thereafter remit an amount of money greater than a threshold money amount. The method includes detecting, by the processor, abnormal overall user behavior, based a joint user profile determined across all users from the login activities, the remittance activities, and the account activities. The method includes aggregating, by the processor, detection results to generate a final list of suspicious transactions. The method includes performing, by the processor, loss preventative actions for each of the suspicious transactions in the final list.

### RELATED APPLICATION INFORMATION

This application claims priority to U.S. Provisional Patent Application Ser. No. 62/520,664, filed on Jun. 17, 2017, incorporated herein by reference herein its entirety. This application is related to an application entitled “Banking Using Suspicious Remittance Detection Through Financial Behavior Analysis”, having attorney docket number 17027B, and which is incorporated by reference herein in its entirety.

### BACKGROUND

### Technical Field

The present invention relates to data processing and more particularly to suspicious remittance detection through financial behavior analysis.

### Description of the Related Art

Financial data includes different types of activities in users' accounts such as, for example, cash withdrawal, account login, money remittance, and so forth. Such activity records naturally form a list of transactions, which include rich features about each transaction. It is critical to detect suspicious transactions to prevent fraud and avoid money loss. Hence, there is a need for a suspicious remittance detection approach capable of such detection.

### SUMMARY

According to an aspect of the present invention, a system is provided for suspicious remittance detection for a set of users. The system includes a memory for storing program code. The system further includes a processor for running the program code to detect unrealistic user location movements, based on login activities and remittance activities. The processor also runs the program code to detect abnormal user remittance behavior based on account activities and the remittance activities by detecting any of the users who are silent for a threshold period of time and thereafter remit an amount of money greater than a threshold money amount. The processor additionally runs the program code to detect abnormal overall user behavior, based a joint user profile determined across all the users from the login activities, the remittance activities, and the account activities. The processor further runs the program code to aggregate detection results to generate a final list of suspicious transactions. The processor also runs the program code to perform one or more loss preventative actions for each of the suspicious transactions in the final list.

According to another aspect of the present invention, a computer-implemented method is provided for suspicious remittance detection for a set of users. The method includes detecting, by a processor, unrealistic user location movements, based on login activities and remittance activities. The method further includes detecting, by the processor, abnormal user remittance behavior based on account activities and the remittance activities by detecting any of the users who are silent for a threshold period of time and thereafter remit an amount of money greater than a threshold money amount. The method also includes detecting, by the processor, abnormal overall user behavior, based a joint user profile determined across all the users from the login activities, the remittance activities, and the account activities. The method additionally includes aggregating, by the processor, detection results to generate a final list of suspicious transactions. The method further includes performing, by the processor, one or more loss preventative actions for each of the suspicious transactions in the final list.

According to yet another aspect of the present invention, a computer program product is provided for suspicious remittance detection for a set of users. The computer program product includes a non-transitory computer readable storage medium having program instructions embodied therewith. The program instructions are executable by a computer to cause the computer to perform a method. The method includes detecting, by a processor of the computer, unrealistic user location movements, based on login activities and remittance activities. The method further includes detecting, by the processor, abnormal user remittance behavior based on account activities and the remittance activities by detecting any of the users who are silent for a threshold period of time and thereafter remit an amount of money greater than a threshold money amount. The method also includes detecting, by the processor, abnormal overall user behavior, based a joint user profile determined across all the users from the login activities, the remittance activities, and the account activities. The method additionally includes aggregating, by the processor, detection results to generate a final list of suspicious transactions. The method further includes performing, by the processor, one or more loss preventative actions for each of the suspicious transactions in the final list.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary system for suspicious remittance detection through financial behavior analysis, in accordance with an embodiment of the present invention;

FIG. 2 is a block diagram showing an exemplary system for banking with suspicious remittance detection through financial behavior analysis, in accordance with an embodiment of the present invention;

FIG. 3 is a block diagram showing an exemplary processing system to which the invention principles may be applied, in accordance with an embodiment of the present invention; and

FIGS. 4-6 are flow diagrams showing a method for suspicious remittance detection through financial behavior analysis, in accordance with an embodiment of the present invention.

### DETAILED DESCRIPTION OF PREFERRED EMBODIMENTS

The present invention is directed to suspicious remittance detection through financial behavior analysis.

The present invention develops a collection of financial fraud detectors to detect suspicious remittances from financial transactions by jointly considering login activities, account activities, and remittance activities from different users. The account can be one set up with an e-merchant, an e-marketplace, an e-commerce website, a bank, and so forth, as readily appreciated by one of ordinary skill in the art.

In an embodiment, the present invention uses a presumption that normal users usually have a consistent frequency of activities.

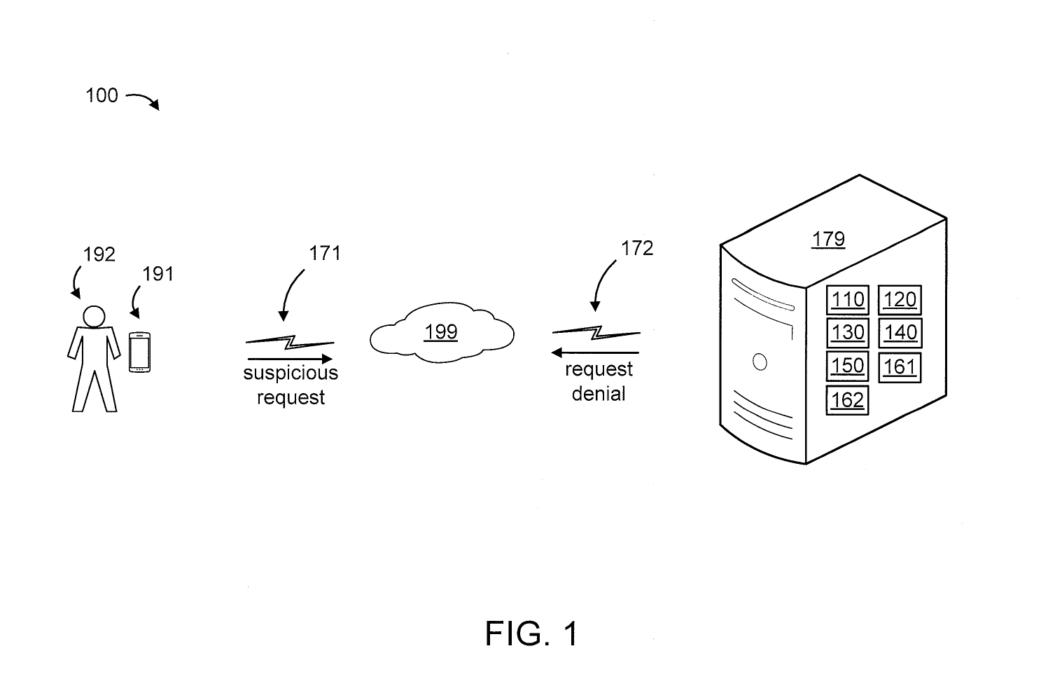

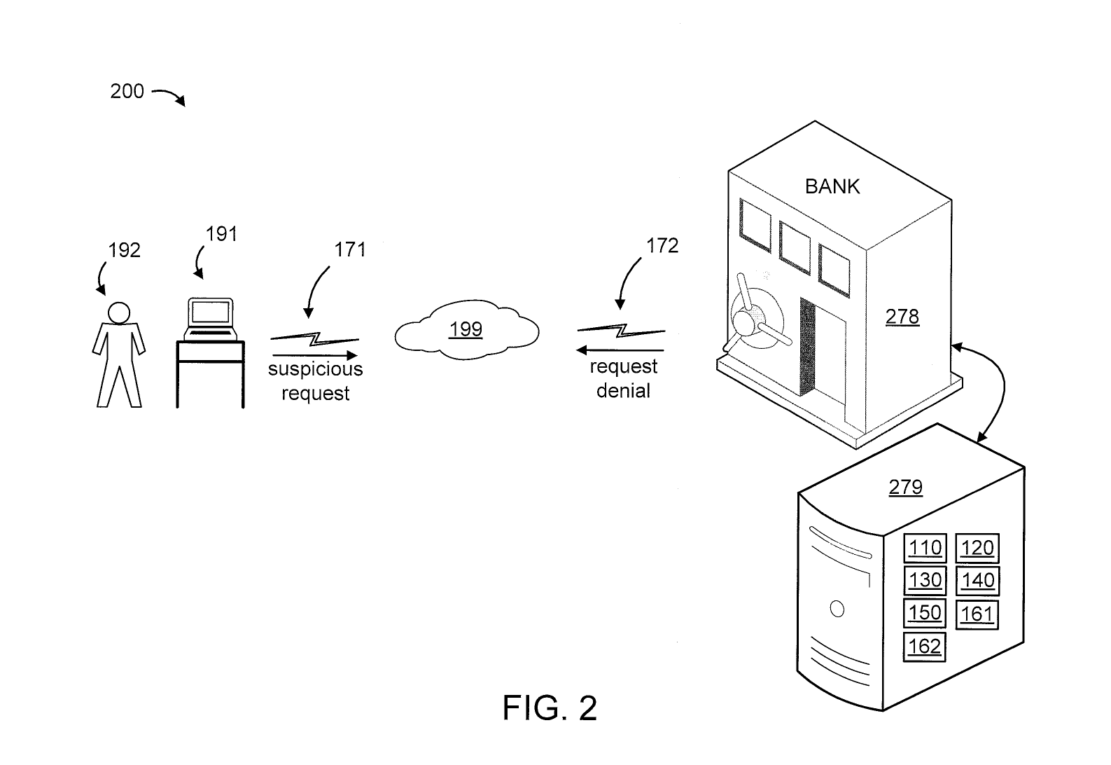

For the sake of illustration, the present invention will be initially described with respect to a system 100 for suspicious remittance detection through financial behavior analysis in relation to FIG. 1. Thereafter, the present invention will be described with respect to a system 200 for banking using suspicious remittance detection through financial behavior analysis in relation to FIG. 2. As some elements are common to both systems 100 and 200, detailed descriptions of such common elements will be described subsequent to the descriptions of FIGS. 1 and 2 to avoid redundant element descriptions.

FIG. 1 is a block diagram showing an exemplary system 100 for suspicious remittance detection through financial behavior analysis, in accordance with an embodiment of the present invention.

The system 100 includes a location-based detector 110, a remittance frequency based detector 120, an anomaly account activity user behavior detector 130, a fusion mechanism 140, and a controller 150. The system 100 further includes one or more memory devices (hereinafter referred to in singular form, and collectively denoted by the figure reference numeral 161) and a transceiver 162. In an embodiment, elements 110, 120, 130, 140, 150, 161, and 162 are implemented by a server 179. In the embodiment of FIG. 1, the server 179 can be under the control of an entity (hereinafter “controlling entity”). In an embodiment, the controlling entity can be, for example, an e-commerce website, an agent of an e-commerce website, and so forth

In an embodiment, the system 100 interacts with computing devices 191 of a set of users 192 via one or more networks (collectively denoted by the figure reference numeral 199). For example, a user 192 may initiate a suspicious request 171 through their computing device 191, which may then be processed by the server 179. Upon determining that the request 171 is suspicious, the server 179 may return a request denial 172 to the computing device 191. In the embodiment of FIG. 1, a single user 192 and computing device 191 are shown for the sake of illustration. However, system 100 can be applied to any number of users and corresponding computing devices, while maintaining the spirit of the present invention. In the embodiment of FIG. 1, the computer device 191 of the user 192 is a smartphone.

System 100 can be deployed for any remittance transactions wherein a user intends to obtain money or other pecuniary benefit, whether contemporaneously and subsequently. Such obtaining can involve an outright withdrawal, a transfer, a purchase, and so forth, as readily appreciated by one of ordinary skill in the art, given the teachings of the present invention provided herein.

Accordingly, system 100 can be deployed for purchases from e-commerce web sites and so forth, as readily appreciated by one of ordinary skill in the art.

FIG. 2 is a block diagram showing an exemplary system 200 for banking with suspicious remittance detection through financial behavior analysis, in accordance with an embodiment of the present invention.

Similar to system 100, system 200 includes a location-based detector 110, a remittance frequency based detector 120, an anomaly account activity user behavior detector 130, a fusion mechanism 140, and a controller 150. The system 200 further includes one or more memory devices (hereinafter referred to in singular form, and collectively denoted by the figure reference numeral 161) and a transceiver 162. In an embodiment, elements 110, 120, 130, 140, 150, 161, and 162 are implemented by a server 279. In the embodiment of FIG. 2, the server 279 can be under the control of an entity such as bank 278 or an agent of the bank 278.

In an embodiment, the system 200 interacts with computing devices 191 of a set of users 192 via one or more networks (collectively denoted by the figure reference numeral 199). For example, a user 192 may initiate a suspicious request 171 through their computing device 191, which may then be processed by the server 279. Upon determining that the request 171 is suspicious, the server 279 may return a request denial 172 to the computing device 191. In the embodiment of FIG. 2, a single user 192 and computing device 191 are shown for the sake of illustration. However, system 200 can be applied to any number of users and corresponding computing devices, while maintaining the spirit of the present invention. In the embodiment of FIG. 2, the computer device 191 of the user 192 is a desktop computer.

In contrast to the more general applicability of system 100, system 200 is specifically directed to banking. Accordingly, elements of system 200 can be implemented by one or more servers and/or other computing devices/systems that are presumably under the control of the bank or an agent (authorized entity) of the bank for the purpose of maintaining banking transaction integrity.

Of course, other configurations and/or deployments can be used for system 100 and/or system 200, given the teachings of the present invention provided herein, while maintaining the spirit of the present invention.

Further descriptions will now be given regarding various elements common to system 100 and system 200. It is to be appreciated that while the elements may be common in name, their functionality may vary from system 100 to system 200 and even from different versions/deployments/etc. of the same system (100 and/or 200). However, in many cases, the controlling party (e-commerce website, bank) will dictate the variations, based on their needs and intentions.

Regarding the computing devices 191 of the users 192, the same can be any type of computing device that can be used for financial transactions including, but not limited to, personal computers, laptops, tablets, smartphones, media devices, and so forth. It is to be appreciated that the preceding list of computing devices is merely illustrative.

Regarding the location-based detector 110, the same utilizes both login activities and remittance activities to detect unrealistic location movements of each of the users 192.

For each user, we first extract all the user's login activities, and extract precise location information such as latitude/longitude, country, and city from each login Internet Protocol (IP) address. After that, we take the differential for each two consecutive records to compute (1) the time difference and (2) the coordinate difference, between the two records. After that, we can compute the location switching speed by coordinate difference/time difference. We set a speed threshold, e.g., 5000 km/hour, the fastest airplane speed, and detect any speed that is greater than the threshold, considering such speed an unrealistic (too fast) travel speed. Records with unrealistic speed indicate that the two logins are not able to be done by a single person, which means the account is controlled by someone other than the owner. We do this for all users 192 and detect the users that generate unrealistic movements and label such users as suspicious users.

Regarding the remittance frequency based detector 120, the same utilizes both remittance activities and account activities to detect users who are silent for a long time and suddenly remit a large amount of money. For each user, we first examine if the user has been silent (does not have any activities) for a time period longer than a threshold time period (e.g., six months, etc.), and then remits money. We list all the users with such behavior. Then, for each of the listed users, we check if their remittance percentage is higher than a threshold, e.g., 75%, and list those users. In this way, we find users who do have any account activity for a long time, and suddenly send out a large portion of money, considering their behavior as abnormal compared to their history.

Regarding the anomaly account activity user behavior detector 130, the same utilizes login activities, remittance activities, and account activities to jointly profile normal behavior of a majority of users, and uses such a profile to detect users whose behaviors are significantly different from normal behaviors. We extract three features as follows: (1) IP ratio, which is the number of unique Internet Protocol (IP) address divided by the number of login attempts; (2) remittance ratio, which is the remittance amount divided by the total account balance; and (3) remittance activity ratio, which is the number of remittance activities divided by the number of total account activities. These three features represent three dimensions of typical user behaviors. For the three features of all the users, we then use a density-based clustering algorithm to scan the data. This will find a major cluster where points are very close to each other, and several clusters where points are far from the major cluster. Users that do not belong to the major cluster are labeled as suspicious users considering their behavior is very different from majority of users.

Regarding the fusion mechanism 140, the same aggregates detection results from all three detectors 110, 120, and 130 to generate a final list 180 of suspicious transactions. To that end, the fusion mechanism can perform clustering as described further herein in order to identify suspicious transactions.

Regarding the controller 150, initiates the performance of an action responsive to the final list 180 of suspicious transactions. Various exemplary actions are described herein.

Regarding the memory device 161, the same is used to store program code for enabling various aspects of the present invention and can be used by one or more other elements of the systems including, for example, controller 150.

Regarding the transceiver 162, the same is used to enable communication of the systems (100 and/or 200) with user devices 191.

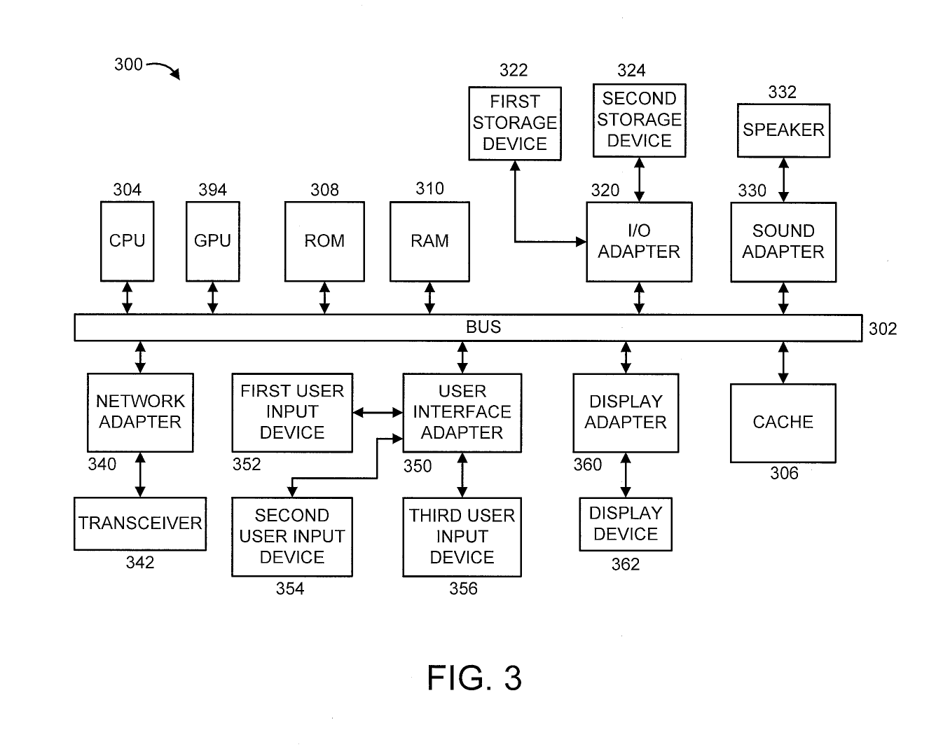

FIG. 3 is a block diagram showing an exemplary processing system 300 to which the invention principles may be applied, in accordance with an embodiment of the present invention. In an embodiment, system 300 can be representative of a computing device 191 of a user 192. In an embodiment, system 300 can comprise one or more elements of systems 100 and/or 200. In an embodiment, elements of system 300 can form a server. The server can be used by an e-commerce website, a bank or other financial institution, and so forth, as readily appreciated by one of ordinary skill in the art, given the teachings of the present invention provided herein.

The processing system 300 includes at least one processor (CPU) 304 operatively coupled to other components via a system bus 302. A cache 306, a Read Only Memory (ROM) 308, a Random Access Memory (RAM) 310, an input/output (I/O) adapter 320, a sound adapter 330, a network adapter 340, a user interface adapter 350, and a display adapter 360, are operatively coupled to the system bus 302. At least one Graphics Processing Unit (GPU) 394 is operatively coupled to at least the processor 304 via system bus 302.

A first storage device 322 and a second storage device 324 are operatively coupled to system bus 302 by the I/O adapter 320. The storage devices 322 and 324 can be any of a disk storage device (e.g., a magnetic or optical disk storage device), a solid state magnetic device, and so forth. The storage devices 322 and 324 can be the same type of storage device or different types of storage devices.

A speaker 332 is operatively coupled to system bus 302 by the sound adapter 330. A transceiver 342 is operatively coupled to system bus 302 by network adapter 340. A display device 362 is operatively coupled to system bus 302 by display adapter 360.

A first user input device 352, a second user input device 354, and a third user input device 356 are operatively coupled to system bus 302 by user interface adapter 350. The user input devices 352, 354, and 356 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 352, 354, and 356 can be the same type of user input device or different types of user input devices. The user input devices 352, 354, and 356 are used to input and output information to and from system 300.

Of course, the processing system 300 may also include other elements (not shown), as readily contemplated by one of skill in the art, as well as omit certain elements. For example, various other input devices and/or output devices can be included in processing system 300, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 300 are readily contemplated by one of ordinary skill in the art given the teachings of the present invention provided herein.

Moreover, it is to be appreciated that system 100 described above with respect to FIG. 1 is a system for implementing respective embodiments of the present invention. It is to be further appreciated that system 200 described above with respect to FIG. 2 is a system for implementing respective embodiments of the present invention. Part or all of processing system 300 may be implemented in one or more of the elements of system 100 and/or system 200.

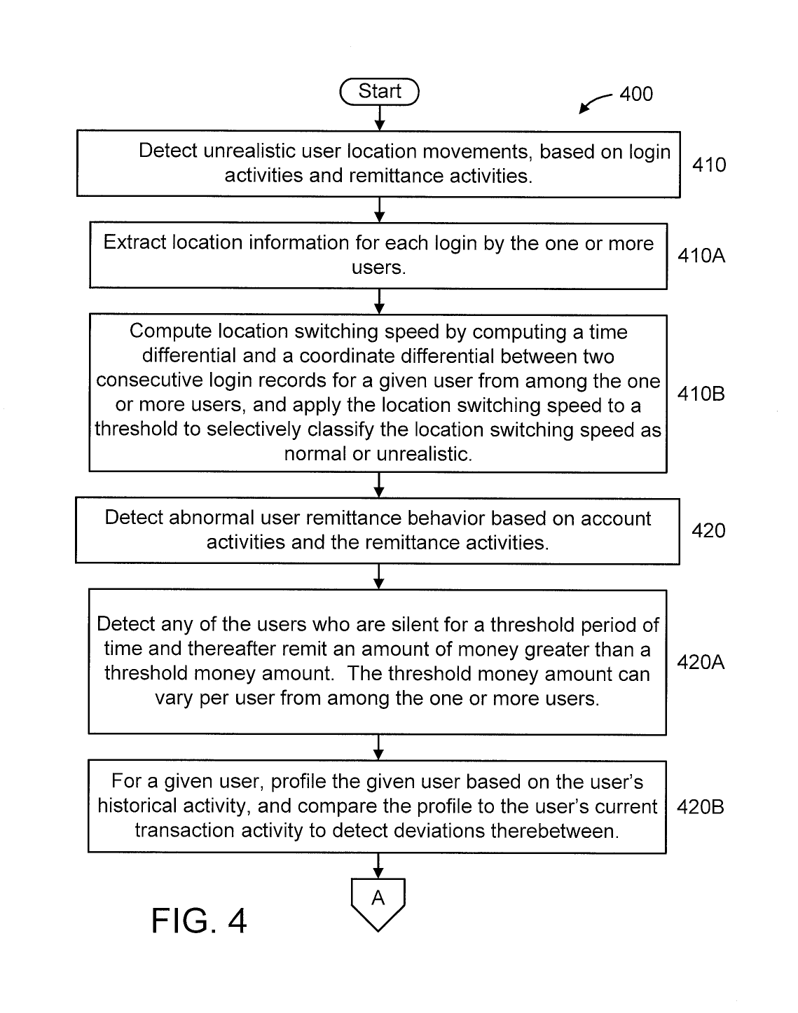

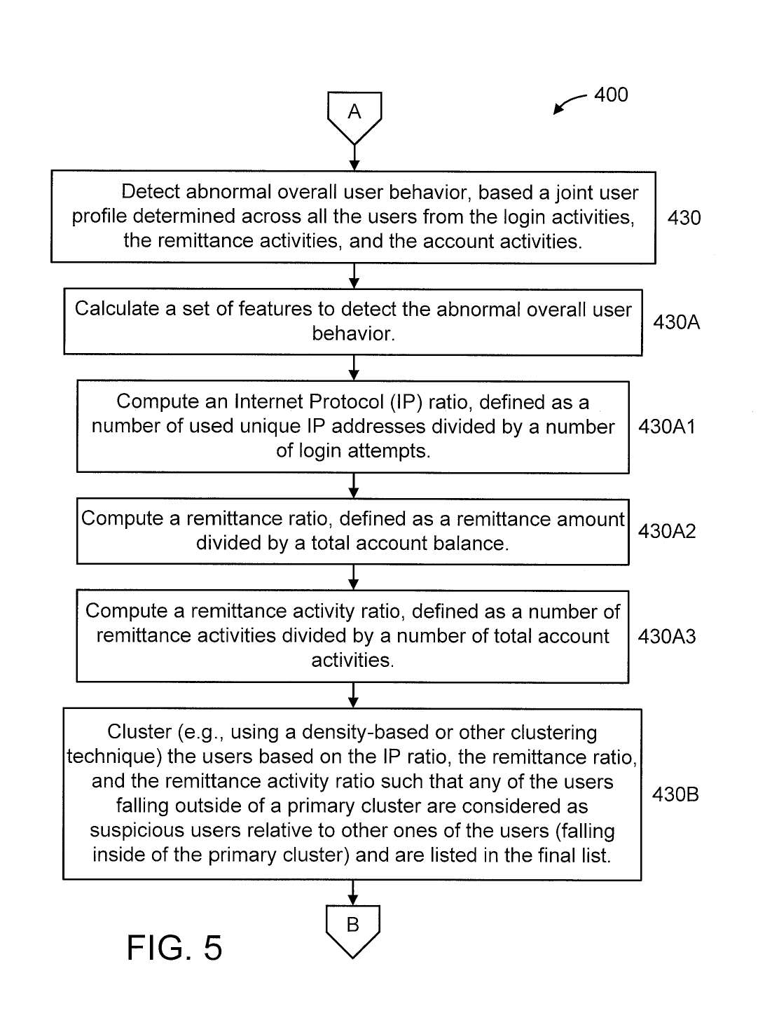

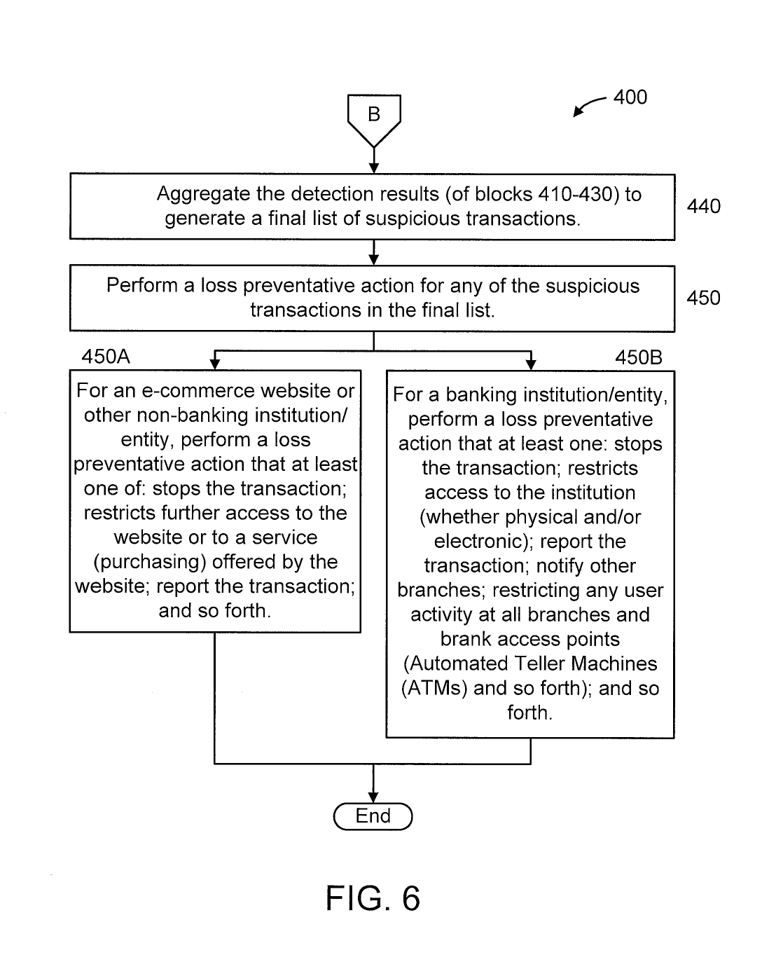

Further, it is to be appreciated that processing system 300 may perform at least part of the method described herein including, for example, at least part of method 400 of FIGS. 4-6. Similarly, part or all of system 100 and/or system 200 may be used to perform at least part of method 400 of FIGS. 4-6.

FIGS. 4-6 are flow diagrams showing a method 400 for suspicious remittance detection through financial behavior analysis, in accordance with an embodiment of the present invention.

At block 410, detect unrealistic user location movements, based on login activities and remittance activities.

In an embodiment, block 410 can include one or more of blocks 410A and 410B.

At block 410A, extract location information for each login by the one or more users.

At block 410B, compute location switching speed by computing a time differential and a coordinate differential between two consecutive login records for a given user from among the one or more users, and apply the location switching speed to a threshold to selectively classify the location switching speed as normal or unrealistic.

At block 420, detect abnormal user remittance behavior based on account activities and the remittance activities.

In an embodiment, block 420 can include one or more of blocks 420A-420B.

At block 420A, detect any of the users who are silent for a threshold period of time and thereafter remit an amount of money greater than a threshold money amount. In an embodiment, the threshold money amount can vary per user from among the one or more users.

At block 420B, for a given user, profile the given user based on the user's historical activity, and compare the profile to the user's current transaction activity to detect deviations therebetween. In an embodiment, the deviations to be detected are specifically directed to abnormal user remittance behavior.

At block 430, detect abnormal overall user behavior, based a joint user profile determined across all the users from the login activities, the remittance activities, and the account activities.

In an embodiment, block 430 can include one or more of blocks 430A-430B.

At block 430A, calculate a set of features to detect the abnormal overall user behavior.

In an embodiment, block 430A can include one or more of blocks 430A1-430A3.

At block 430A1, compute an Internet Protocol (IP) ratio, defined as a number of used unique IP addresses divided by a number of login attempts.

At block 430A2, compute a remittance ratio, defined as a remittance amount divided by a total account balance.

At block 430A3, compute a remittance activity ratio, defined as a number of remittance activities divided by a number of total account activities.

At block 430B, cluster the users based on the IP ratio, the remittance ratio, and the remittance activity ratio such that any of the users falling outside of a primary cluster are considered as suspicious users relative to other ones of the users (falling inside of the primary cluster) and are listed in the final list. In an embodiment, a density-based clustering technique can be used, as well as other clustering techniques, while maintaining the spirit of the present invention.

At block 440, aggregate the detection results (of blocks 410-430) to generate a final list of suspicious transactions. In an embodiment, the final list of suspicious transactions involves one or more of the users for which at least metric is implicated as follows: unrealistic user location movements; the abnormal user remittance behavior; and the abnormal overall user behavior.

At block 450, perform a loss preventative action for any of the suspicious transactions in the final list. The loss preventative action can include, for example, but is not limited to, halting the transaction, restricting access to one or more services/sites/transactions/etc., reporting the transaction to one or more entities (e.g., bank, police, etc.), and so forth. As is evident to one of ordinary skill in the art, the action(s) taken is(are) dependent upon the type of application to which the present invention is applied.

In an embodiment, block 450 can include one or more of blocks 450A and 450B.

At block 450A, for an e-commerce website or other non-banking institution/entity, perform a loss preventative action that at least one of: stops the transaction; restricts further access to the website or to a service (purchasing) offered by the website; report the transaction; and so forth.

At block 450B, for a banking institution/entity, perform a loss preventative action that at least one: stops the transaction; restricts access to the institution (whether physical and/or electronic); report the transaction; notify other branches; restricting any user activity at all branches and brank access points (Automated Teller Machines (ATMs) and so forth); and so forth.

A description will now be given of some of the many attendant advantages of the present invention, in accordance with one or more embodiments of the present invention.

The present invention produces high quality results to detect suspicious users and their suspicious remittance transactions. First, this will directly benefit financial institutes to stop fraud and suspicious money transactions to avoid money loss.

Moreover, the present invention can be used to create more sophisticated rules, and further improve the banking system.

Further, with a high detection accuracy, banks will reduce the workload, such as, for example, verification phone calls, to handle suspicious transactions, which improves efficiency.

Also, rather than conventional approaches that check login logs and focus on one record at a time, the present invention uses consecutive logins to check a user's location movement and detect suspicious logins (e.g., per the location-based detector).

Additionally, rather than conventional approaches that mainly focus on remittance amount to detect suspicious remittance, the present invention personalizes it to each user and tracks the user's historical activity to detect suspicious remittance (e.g., per the remittance frequency based detector).

Moreover, rather than focusing on each individual feature, the present invention jointly considers multiple features together to detect users that are dissimilar with respect to other users (e.g., per the anomaly account activity user behavior detector).

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A system for suspicious remittance detection for a set of users, comprising:
a memory for storing program code; and
a processor for running the program code to
detect unrealistic user location movements, based on login activities and remittance activities;
detect abnormal user remittance behavior based on account activities and the remittance activities by detecting any of the users who are silent for a threshold period of time and thereafter remit an amount of money greater than a threshold money amount;
detect abnormal overall user behavior, based a joint user profile determined across all the users from the login activities, the remittance activities, and the account activities;
aggregate detection results to generate a final list of suspicious transactions; and
perform one or more loss preventative actions for each of the suspicious transactions in the final list.

2. The system of claim 1, wherein the processor detects the unrealistic user location movements by extracting location information for each login by the one or more users and computing a user location switching speed based on the login information.

3. The system of claim 2, wherein the processor computes the user location switching speed by computing a time differential and a coordinate differential between two consecutive login records for a given user from among the one or more users, and applies the user location switching speed to a threshold to selectively classify the user location switching speed as normal or unrealistic.

4. The system of claim 1, wherein the threshold money amount varies per user from among the one or more users.

5. The system of claim 1, wherein at least some of the login activities, the remittance activities, and the account activities are used to calculate a set of features to detect the abnormal overall user behavior.

6. The system of claim 5, wherein, for a given user, the set of features comprise an Internet Protocol (IP) ratio, defined as a number of used unique IP addresses divided by a number of login attempts.

7. The system of claim 5, wherein, for a given user, the set of features comprise a remittance ratio, defined as a remittance amount divided by a total account balance.

8. The system of claim 5, wherein, for a given user, the set of features comprise a remittance activity ratio, defined as a number of remittance activities divided by a number of total account activities.

9. The system of claim 5, wherein, for a given user, the set of features comprise an Internet Protocol (IP) ratio defined as a number of used unique IP addresses divided by a number of login attempts, a remittance ratio defined as a remittance amount divided by a total account balance, and a remittance activity ratio defined as a number of remittance activities divided by a number of total account activities.

10. The system of claim 9, further comprises clustering the users based on the IP ratio, the remittance ratio, and the remittance activity ratio such that any of the users falling outside of a primary cluster are considered as suspicious users relative to other ones of the users and are listed in the final list.

11. The system of claim 1, wherein the final list of suspicious transactions involves one or more of the users for which at least metric is implicated selected from the group consisting of the unrealistic user location movements, the abnormal user remittance behavior, and the abnormal overall user behavior.

12. A computer-implemented method for suspicious remittance detection for a set of users, comprising:
detecting, by a processor, unrealistic user location movements, based on login activities and remittance activities;
detecting, by the processor, abnormal user remittance behavior based on account activities and the remittance activities by detecting any of the users who are silent for a threshold period of time and thereafter remit an amount of money greater than a threshold money amount;
detecting, by the processor, abnormal overall user behavior, based a joint user profile determined across all the users from the login activities, the remittance activities, and the account activities;
aggregating, by the processor, detection results to generate a final list of suspicious transactions; and
performing, by the processor, one or more loss preventative actions for each of the suspicious transactions in the final list.

13. The computer-implemented method of claim 12, wherein the processor detects the unrealistic user location movements by extracting location information for each login by the one or more users and computing a user location switching speed based on the login information.

14. The computer-implemented method of claim 13, wherein the processor computes the user location switching speed by computing a time differential and a coordinate differential between two consecutive login records for a given user from among the one or more users, and applies the user location switching speed to a threshold to selectively classify the user location switching speed as normal or unrealistic.

15. The computer-implemented method of claim 12, wherein the threshold money amount varies per user from among the one or more users.

16. The computer-implemented method of claim 12, wherein at least some of the login activities, the remittance activities, and the account activities are used to calculate a set of features to detect the abnormal overall user behavior.

17. The computer-implemented method of claim 16, wherein, for a given user, the set of features comprise an Internet Protocol (IP) ratio, defined as a number of used unique IP addresses divided by a number of login attempts.

18. The computer-implemented method of claim 16, wherein, for a given user, the set of features comprise a remittance ratio, defined as a remittance amount divided by a total account balance.

19. The computer-implemented method of claim 16, wherein, for a given user, the set of features comprise a remittance activity ratio, defined as a number of remittance activities divided by a number of total account activities.

20. A computer program product for suspicious remittance detection for a set of users, the computer program product comprising a non-transitory computer readable storage medium having program instructions embodied therewith, the program instructions executable by a computer to cause the computer to perform a method comprising:
detecting, by a processor of the computer, unrealistic user location movements, based on login activities and remittance activities;
detecting, by the processor, abnormal user remittance behavior based on account activities and the remittance activities by detecting any of the users who are silent for a threshold period of time and thereafter remit an amount of money greater than a threshold money amount;
detecting, by the processor, abnormal overall user behavior, based a joint user profile determined across all the users from the login activities, the remittance activities, and the account activities;
aggregating, by the processor, detection results to generate a final list of suspicious transactions; and
performing, by the processor, one or more loss preventative actions for each of the suspicious transactions in the final list.
